(19) United States
(12) Patent Application Publication
(10) Pub. No.: US 2015/0379463 A1
(43) Pub. Date: Dec. 31, 2015

(54) Systems and Methods for a Receptacle and Related Devices

(71) Applicant: Ritimukta Sarangi, Palo Alto, CA (US)

(72) Inventor: Ritimukta Sarangi, Palo Alto, CA (US)

(21) Appl. No.: 14/754,101

(22) Filed: Jun. 29, 2015

Related U.S. Application Data
(60) Provisional application No. 62/018,302, filed on Jun. 27, 2014.

(51) Int. Cl. G06Q 10/08; G01G 15/02; G06Q 30/06

(52) U.S. Cl. CPC G06Q 10/087; G06Q 30/0633; G01G 15/02

(57) ABSTRACT

An example method comprises receiving, at a server system, a data message sent from a receptacle device via a network, the data message including: a receptacle identifier that uniquely identifies the receptacle device from one or more receptacle devices connected to the server via the network, and sensor data comprising a weight of a consumable disposed within or on the receptacle device, retrieving, by the server based upon the receptacle identifier, a consumable type of the consumable, retrieving, by the server based on the consumable type or the receptacle identifier, a predetermined consumable rule, comparing, by the server, the weight of the consumable with a threshold weight defined in the predetermined consumable rule, and providing an alert, by the server in response to the comparison, to a remote user device.

### CROSS-REFERENCE TO RELATED APPLICATION

The present application claims priority from U.S. Provisional Patent Application No. 62/018,302, filed Jun. 27, 2014, entitled “Systems and Methods for Product Consumption, Health, Purchase Management,” which is hereby incorporated by reference herein.

### BACKGROUND

1. Field of the Invention(s)

The present invention(s) relate generally to consumable storage. More particularly, the invention(s) relate to systems and methods which utilize network-based services to analyze consumable data detected from sensors disposed within receptacles.

2. Description of Related Art

There are a variety of containers and other storage options currently available to consumers. Indeed, there are companies solely devoted to providing storage containers. However, these containers have remained more or less the same over the years, with limited improvement. For example, containers come in a variety of sizes and materials, with different types of lids, but otherwise, they typically remain the same.

Developments in healthcare and nutrition have also provided consumers with a larger variety of goods, including “healthy” options. For example, consumers can more easily find low-carb snacks, high protein shakes, and the like. However, although consumers have a greater variety of options at the grocery store or shopping online, it remains difficult to track and manage personal nutrition.

### SUMMARY

An example method comprises receiving, at a server system, a data message sent from a receptacle device via a network, the data message including: a receptacle identifier that uniquely identifies the receptacle device from one or more receptacle devices connected to the server via the network, and sensor data comprising a weight of a consumable disposed within or on the receptacle device, retrieving, by the server based upon the receptacle identifier, a consumable type of the consumable, retrieving, by the server based on the consumable type or the receptacle identifier, a predetermined consumable rule, comparing, by the server, the weight of the consumable with a threshold weight defined in the predetermined consumable rule, and providing an alert, by the server in response to the comparison, to a remote user device.

In some embodiments, the alert indicates a low quantity of the consumable. The method may further comprise retrieving, by the server in response to the comparison, a supplier identifier based on the consumable type or the receptacle identifier, the supplier identifier associated with the consumable type, generating, by the server, an order data message comprising the consumable type and a consumable quantity, and transmitting, by the server via the network, the order data message to a second server identified by the supplier identifier.

In various embodiments, the method may further comprise retrieving, by the server in response to the comparison, consumable information associated with the consumable type, the consumable information comprising a plurality of supplier identifiers each associated with a consumable price and the consumable type, selecting, by the server, a first supplier identifier from the plurality of supplier identifiers based on the associated consumable price for said first supplier identifier, generating, by the server, an order data message comprising the consumable type and a consumable quantity, and transmitting, by server via the network, the order data message to a second server identified by the first supplier identifier. The consumable quantity may be determined, by the server, using the weight from the sensor data. The order message may be generated and transmitted without instruction from the remote user device.

The method may further comprise receiving, at the server, a second data message sent from a second receptacle device via the network, the second data message including: a second receptacle identifier that uniquely identifies the second receptacle device from a plurality of receptacle devices connected to the server via the network and sensor data comprising a weight of a second consumable disposed within or on the second receptacle device, retrieving, by the server based upon the second receptacle identifier, a consumable type of the second consumable, retrieving, by the server, nutritional data comprising (i) one or more nutrients associated with the consumable type of the first consumable, (ii) one or more nutrients associated with the consumable type of the second consumable, each of the nutrients having an associated nutrient weight, retrieving, by the server based on the nutritional data, a predetermined nutritional rule, calculating, by the server, a nutritional value from the nutritional data using the weight from the data message and the weight from the second data message, comparing, by the server, the nutritional value with a threshold condition of the nutritional rule, providing a second alert, by the server based upon the comparison, to the remote user device indicating nutritional information.

The weight in the data message and the second data messages may each comprise a change in weight over a predetermined amount of time. In some embodiments, the method further comprises determining, by the processor, (i) a first carbohydrate weight for the consumable using the nutritional data and the sensor data from the data message, and (ii) a second carbohydrate weight for the second consumable using the nutritional data and the sensor data from the second data message. The nutritional value may comprise an aggregate of the first carbohydrate weight and the second carbohydrate weight. The nutritional information may comprise (i) the nutritional value and (ii) and an excess weight of carbohydrates, the excess weight calculated using the threshold weight of the nutritional rule and the aggregate weight.

An example system may comprise a processor, a registration database, a consumable rules database, a communication module, a registration module, and a rule module. The registration database may be configured to cooperate with the processor store a plurality receptacle records, each receptacle record comprising a receptacle identifier and a consumable type. The consumable rules database may be configured to cooperate with the processor to store a plurality of consumable rules, each consumable rule associated with a consumable type. The communication module may be configured to cooperate with the processor to receive a data message sent from a receptacle device, the data message including a receptacle identifier that uniquely identifies the receptacle device from a plurality of receptacle devices connected to the server via a network and sensor data comprising a weight of a consumable disposed within or on the receptacle device. The registration module may be configured to cooperate with the processor to retrieve from the registration database, based on the receptacle identifier, a consumable type associated with the receptacle identifier. The rule module may be configured to cooperate with the processor to:
(i) retrieve from the consumable rules database a first consumable rule associated with the retrieved consumable type,
(ii) determine, based on the first consumable rule, whether the weight of the consumable meets or exceeds a threshold weight identified in the first consumable rule,
(iii) provide an alert, in response to a determination by the processor that the weight of the consumable meets or exceeds the threshold weight identified in the first consumable rule, to a remote user device.

### BRIEF DESCRIPTION OF THE DRAWINGS

FIG. 1A is diagram of a receptacle device for storing and/or measuring consumables according to some embodiments.

FIG. 1B is diagram of a sensor device according to some embodiments.

FIG. 1C is diagram of a sensor device with multiple weighing areas according to some embodiments.

FIG. 2 illustrates a system and environment for collecting and analyzing consumable data according to some embodiments.

FIG. 3 is an example method of operation of a receptacle device according to some embodiments.

FIG. 4 is a block diagram of a server according to some embodiments.

FIG. 5 is an example method of operation of a server executing consumable rules according to some embodiments.

FIG. 6 is an example method of operation of a server executing consumable rules and nutrition rules according to some embodiments.

FIG. 7 is an example method of operation of a server executing game rules according to some embodiments.

FIG. 8 is an example method of user account registration and receptacle device registration by a server according to some embodiments.

FIG. 9 is a block diagram of a digital device according to some embodiments.

### DETAILED DESCRIPTION

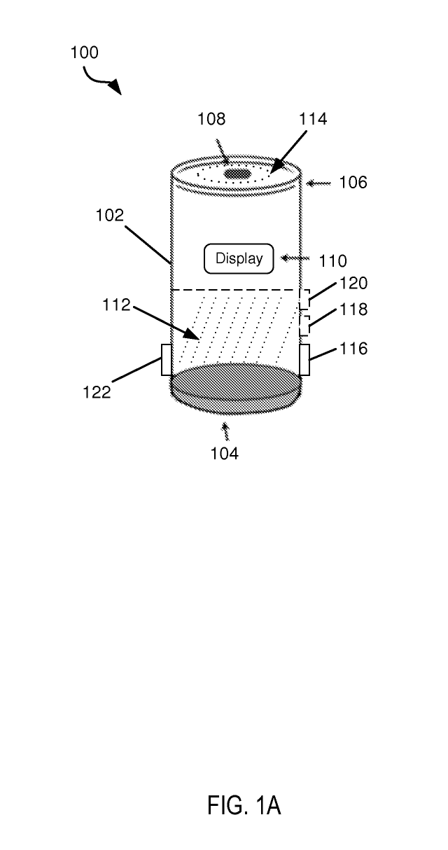

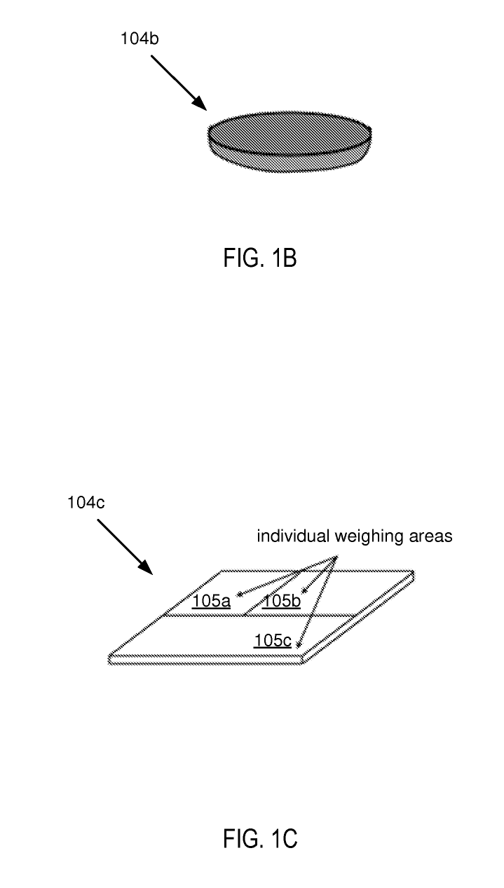

FIG. 1A is a diagram of a receptacle device 100 for storing and/or measuring consumables according to some embodiments. The receptacle device 100 may provide, for example, a solution for real-time tracking, management, and/or procurement of consumable goods and/or products.

In the illustrated example of FIG. 1A, the receptacle device 100 may include a housing 102, a weight sensor 104, a lid 106, a tag 108, and a display 110. In some embodiments, the housing 102 may receive and store consumable goods 112, such as kitchen food goods (e.g., sugar, rice, salt, milk. water, etc.), medicine (e.g., pills), household goods (e.g., facial tissue), and the like. It will be appreciated that the housing 102 may be any shape. For example, the housing 102 may have a cylindrical shape (as shown), such as a jar, although in other embodiments it may have other shapes (e.g., a box, spherical, oblong, or the like). In various embodiments, the receptacle device 100 may have a flat (or substantially flat) shape (e.g., a dish, plate, baking pan, sheet pan, a basket, and not include a housing at all). These other shapes may be helpful, for example, for storing larger household items, such as paper towels, which are not suitable for jars, cans, or similar receptacles. It will be appreciated that the receptacle device 100 may be a non-uniform shape (e.g., a portion of the receptacle device 100 may be one shape while another portion of the receptacle device 100 may be another shape).

Regardless of shape, the housing 102 may be constructed from a variety of materials, such as but not limited to plastic, glass, metal, ceramic, or some combination thereof. In some embodiments, the housing 102 may comprise a multiple-walled housing (e.g., a double-walled housing) in order to facilitate storage of hot and/or cold consumables such as cold water, cold milk, hot soup, and so forth. The housing may be opaque, transparent, include transparent windows, or the like. It will be appreciated that different shapes and materials of the housing 102 may be preferable depending upon the consumable (e.g., for ease of pouring, ease of scooping, protection from light, or the like).

In some embodiments, the housing 102 and lid 106 form a vacuum seal when closed. In various embodiments, the housing 102 and lid 106 may be air-tight, moisture-tight, or semi-permeable (e.g., allowing moisture to transfer out of the container). It will be appreciated that multiple different lids may fit the housing 102 and perform different functions. One lid may provide an air-tight seal when closed while another is semi-permeable. A user may select a lid that best meets the user's needs and/or the requirements of the consumable to be contained in the receptacle device 100.

In some embodiments, the receptacle device 100 may include one or more sensors 104 for measuring weight, volume, temperature, and/or so forth, of the consumable 112 disposed within, or on, the receptacle device 100. In the illustrated embodiment, the sensor 104 is a weight sensor that may detect a weight of the consumable 112 and/or the weight of all or part of the receptacle device 100. For example, the sensor 104 may be a weighing scale, albeit as adapted in accord with the teachings herein. The sensor 104 may be an integral part of the housing 102, or it may be coupled to a portion of the housing 102 (e.g., a bottom portion of the housing 102). It will be appreciated that the sensor 104 may be interchangeable with one or more other sensors. For example, a user may utilize different sensors and couple the sensor(s) to the housing 102 depending on what the user wishes to measure and/or the consumable to be contained in the receptacle device 100.

Any number of sensors may be utilized with the receptacle device 100. For example, an optional second sensor 114 may be disposed within a top portion of the housing 102. The second sensor 114 may, for example, measure a weight of one or more items (e.g., another receptacle device, another consumable, or the like) disposed on top of the receptacle device 100. The weight detected by the second sensor 114 may be used to calculate an accurate measurement of the consumable 112, e.g., by subtracting the weight detected by the second sensor from the weight detected by the first sensor 104. This can be helpful, for example, in situations where it is desirable to stack receptacles and/or consumables (e.g., in a kitchen cabinet, pantry, or closet).

In the illustrated embodiment, a weight value may be calculated by the sensor 104 based on one or more measurements detected by the sensor 104 and/or sensor 114. For example, the weight value may be a weight of the consumable 112 detected from a single reading by the sensor 104 (e.g., 20 grams). By way of further example, the weight value may be an average of several weights detected by the sensor 104 and/or sensor 114, which may improve measurement accuracy. It will be appreciated that the weight value may be represented in a variety of different units (e.g., metric or imperial). In some embodiments, the sensor 104 and/or a different device may remove the weight of the housing and/or other weights that may influence measurement(s) to provide a more accurate weight of the consumable.

In some embodiments, the weight value may comprise a difference of two or more measurements detected by the sensor 104 and/or sensor 114. For example, when the receptacle device 100 is filled with the consumable 112, it may take a first measurement. A second measurement may be taken, e.g., in response to triggering by the motion sensor 118 (discussed below) or after a predetermined amount of time, such as one day. A difference between the two measurements may be determined, thereby yielding a change in weight, or, in a more specific example, a change in weight over time.

In the illustrated embodiment, a top portion of the housing 102 includes a removable lid 106. In some embodiments, as indicated above, the lid 106 may provide a vacuum seal when closed. In other embodiments, the housing 102 may not include the removable lid 106, but rather may be permanently open to the environment (e.g., there is no lid), or permanently closed (e.g., with an opening elsewhere on the housing 102).

In some embodiments, the receptacle device 100 may include an optional tag 108 and/or display 110 disposed within, or on, the housing 102. For example, the tag 108 may include a scannable code (e.g., QR code) printed on the lid 106, or elsewhere on the housing 102. In some embodiments, the tag 108 may be an RFID tag. The tag 108 may facilitate, among other things, identification of the receptacle device 100 and/or consumable disposed therein. The display 110, for example, may display a receptacle or consumable name or identifier associated with the tag 108 or receptacle device 100. In some embodiments, the display 110 may display a current weight of the consumable 112, and/or a color associated with the consumable 112. For example, “healthy” consumables, e.g., low in carbohydrates and/or fat, may display a green color, while “unhealthy” consumables, e.g., high in carbohydrates and/or fat, may display a red color It will be appreciated that the display 110 may be an LED, LCD, E Ink, or other suitable display.

In various embodiments, the display 110 may change color (e.g., glow red) or otherwise notify a user (e.g., with words) when a consumable is low, out, expired, and/or about to expire. In some embodiments, the display 110 may indicate when the power levels of a power supply (e.g., batteries) are low (e.g., with text, symbols such as icons, colors, and/or sound). The display 110 may also indicate if a new power supply and/or consumables have been automatically purchased.

The receptacle device 100 may additionally include a power module 116 for providing electrical power to the sensor 104 and/or other components of the receptacle device 100. The power module 116 may include, for example, one or more rechargeable batteries (e.g., lithium ion), non-rechargeable batteries, capacitors, or any power storage device/medium. In some embodiments, the power module 116 may include a power adapter in addition to, or instead of, the batteries. For example, the power module 116 may include a USB or similar adapter for connection with a computing device, and/or it may include a power adapter for connection to a 120v or 220v electrical outlet. Additionally, although the power module 116 is shown on a bottom, side portion of the housing 102, it will be appreciated this is for illustrative purposes only, and that the power module 116 may be elsewhere on the receptacle device 100. It will be further appreciated that in some embodiments, the power module 116 may comprise a wireless power module in addition to, or instead of, the aforementioned batteries and/or adapters.

The receptacle device 100 may also include an optional movement sensor 118. In some embodiments, the sensor 104 measures a property (e.g., weight) upon sensing of movement by the optional movement sensor 118 (or at a time after movement has been sensed by the optional movement sensor 118 but has since stopped). The optional movement sensor 118 may be helpful for reducing power consumption. For example, the receptacle device 100 may only activate the power module 116 and/or other components of the receptacle device 100 when movement of the receptacle device 100 is detected by the sensor 118. Similarly, the power module 116 may shutoff or reduce consumption of power (e.g., place the receptacle device 100 in a power saving state, hibernation, or the like) for the receptacle device 100 if the movement sensor 118 has not detected any movement within a predetermined amount of time (e.g., 10 minutes). The sensor 118 may, for example, comprise a mechanical switch, mercury switch, and/or some other low-power or ultra-low power switch.

The receptacle device 100 may also include one or more additional sensors 120. The additional sensors 120 may measure, for example, a humidity and/or temperature outside and/or inside the housing 102. For example, humidity and/or temperature values may be used to determine or modify an expiration date for the consumable (e.g., an increased humidity and/or temperature may shorten the amount of time until expiration). In the illustrated embodiment, the additional sensors 120 may include a thermometer(s) and/or hygrometer(s) disposed on an inner or outer portion of the housing 102. In some embodiments, functionality of the sensors 120, and/or sensor 118, may be incorporated into the sensor 104.

The receptacle device 100 may also include a communication module 122. The communication module 122 may be configured to provide or assist in providing communication between the receptacle device 100 and the server system 204 (discussed below). For example, the communication module 122 may establish or receive a communication connection between the receptacle device 100 and the server system 204 (e.g., through a user's smartphone) using network 210 (discussed below) in order to transmit measurements (e.g., weight) detected by sensors 104, 114, or 120, and/or values (e.g., weight values) based on those measurements. The communication connection may comprise one or more wireless connections (e.g., WiFi, Bluetooth, Zigbee, RFID, NFC, and so on) and/or wired connection (e.g., Ethernet cable, USB, and the like). In some embodiments, the communication module 122 may provide a communication connection between different receptacle devices 100 and/or between the receptacle device 100 and a user device 202 (discussed below).

For example, the communication module 122 may enable communication over low power Bluetooth with any number of client devices such as smartphones. The client devices may include any number of applications configured to provide information to a server system including, for example, sensor data (e.g., measurements), container identification information (e.g., a container ID), and/or any other type of information from any number of sensors. In another example, the communication module 122 may enable communication over a local network (e.g., a home WiFi Network, cellular network, or any network) to communicate with the server system as discussed herein.

Although the modules 116-122 are shown disposed on outer portions of the receptacle device 100, it will be appreciated that this is for illustrative purposes only, and in practice the modules 116-122 may be disposed elsewhere on the receptacle device 100. Similarly, functionality of any of the receptacle components 102-120 may be included in one or more of the other components of the receptacle device 100. It will further be appreciated that although the sensors 104 and 114 are shown with an elliptical shape, it will be appreciated that any suitable shape may be used (e.g., a rectangular shape for a box housing).

A module may be hardware, software, or a combination of both. In some embodiments, a module may include a processor and/or memory. In various embodiments, multiple modules (or all modules discussed in FIG. 1A) may utilize or share one or more processors and/or memory.

FIG. 1B is diagram of a sensor device (e.g., weight sensor) 104b according to some embodiments. The sensor 104b may be separate from the housing 102. For example, the sensor 104b may be configured to attach, or otherwise be fitted to, a receptacle (e.g., a jar or a can). The receptacle may be a standard size. Which may allow the receptacle to be fitted to the sensor device 104b. In some embodiments, the sensor device 104b may have a flexible form factor to facilitate, for example, attachment or fitting within a generic receptacle, and/or include additional functionality of the receptacle device 100, e.g., movement sensors, power modules, humidity and/or temperature sensors, communication module, and so forth.

The sensor device 104b may be coupled to the housing 102 in any number of ways including, but not limited to physically (e.g., screw tightening), with glue, friction, Velcro, and/or any other material(s).

FIG. 1C is diagram of a sensor device 104c (e.g., weight sensor) with multiple weighing areas 105a-c according to some embodiments. In some embodiments, the sensor 104c may be used by the receptacle device 100 in place of the sensor 104. Thus, for example, a single receptacle device 100 with a sensor 104c may store and/or measure multiple consumables 112. Additionally, the sensor device 104c may have a flat (or substantially flat) surface, e.g., in the shape of a plate, dish, or pallet, although in other embodiments it may have a similar shape as sensor 104.

It will be appreciated that in some embodiments, the functionality of the receptacle components 102-120 may be implemented in hardware, software, firmware, and/or some combination thereof. It will be further appreciated that some embodiments may have a greater or lesser number of such components 102-120, and/or similar functionality performed by different components.

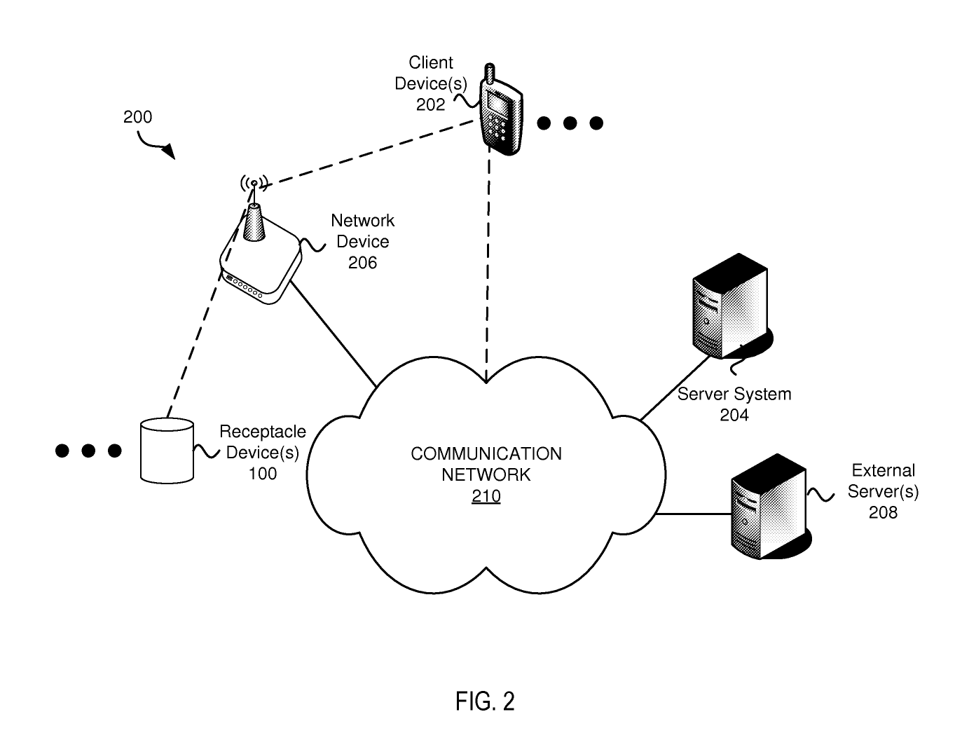

FIG. 2 illustrates a system and environment 200 for collecting and analyzing consumable data according to some embodiments. The example system and environment 200 includes one or more receptacle device(s) 100, one or more client devices 202 (or “user device(s)”), a server system 204, a network device 206, and one or more external server(s) 208. Each of the devices 100 and 202-208 may be operatively coupled to a computer network 210. In the illustrated embodiments the receptacle device(s) 100 be, but is not limited to, one or more of the receptacle devices 100, as described above with reference to FIGS. 1A-C.

The client device 202 may be any digital device capable of data communication with the server system 204, e.g., via a web browser. For example, the client device 202 may be a mobile device, laptop, smartphone, desktop, and so forth. In some embodiments, the client device 202 may even be a server. A digital device is any device with at least one processor and memory.

The server system 204 may include a hardware server, software server, or a combination of both. For example, the server system 204 may comprise a Windows 2003 server, UNIX server, Linux server, and so forth. In various embodiments, the server system 204 is configured to track and manage use and/or procurement of consumables, track and manage personal nutrition based on consumption of goods stored in the receptacle devices 100, and/or provide an interactive game based on the tracked personal nutrition. More specifically, the server system 204 may be configured to execute rules to perform those features. Although only one server system 204 is shown here, this is for illustrative purposes only, and the server system 204 may include any number of digital devices.

Although the server system 204 is depicted as communicating directly over the network 210, the server system 204 may also communicate indirectly over the network 210. In one example, the server system 204 may be a part of or otherwise coupled to the client device 202, or the network device 206. Alternately, it will appreciate that there may be multiple networks and the server system 204 may communicate over all, some, or one of the multiple networks.

The network device 206 may include any number of routers and/or switches. In some embodiments, the server system 204 may manage rights or access to one or more routers or switches. The client device 202 may be required to provide a registration request and receive approval before rights to access the routers or switches are approved. The network device 206 may comprise a standard a wireless router, for example, or it may comprise a special purpose router (e.g., to facilitate communication between the receptacle devices 100 and server system 204).

The computer network 210 may provide communication between the client device 202, the server system 204, network device 206, and/or external servers 208. In some embodiments the network 210 represents one or more network(s) which one or more digital devices may use to communicate. In some examples, the network 210 comprises Ethernet cables, fiber optic, or other wired network topology. In other examples, the network 210 may be wireless and support wireless communication between two or more wireless devices. It will be appreciated that the network 210 may comprise two or more networks, including wired and wireless networks.

In the illustrated embodiment, the network 210 comprises a LAN and/or WAN (e.g., the Internet) network. For example, the network 210 may be a WiFi and/or cellular network, and the client devices 202 and receptacle device 100 may be remote from of the network 210 and/or server system 204.

External server(s) 208 may include any number of servers. The external server(s) 208 may provide additional services to the receptacle device(s) 100, the client device(s) 202, the server system 204, and/or other external servers. External servers may provide services from third parties. For example, an external server 208 may include a retail website (e.g., AMAZON) that is configured to receive information from the receptacle device(s) 100, the client device(s) 202, and/or the server system 204 which may trigger or enable triggering of purchase decisions. As discussed herein, if a consumable in a receptacle device 100 is running low (e.g., below a threshold), the receptacle device(s) 100, the client device(s) 202, and/or the server system 204 may provide an alert to the external server 208 to automatically order more, to place products in a user's cart, or to contact the user (e.g., via email, text, call, or the like) to alert the user.

In another example, the external server 208 may include a social networking server which allows others to be notified of the consumption of a consumable (e.g., a wholesome snack) and/or notified of achievement of objectives or goals.

Like the server system 204, the external server(s) 208 may include a Windows 2003 server, UNIX server, Linux server, and so forth. Although only one external server(s) 208 is shown here, this is for illustrative purposes only, and the external server(s) 208 may include any number of digital devices.

Although the external server(s) 208, like the server system 204, is depicted as communicating directly over the network 210, the external server(s) 208 may also communicate indirectly over the network 210. In one example, the external server(s) 208 may be a part of or otherwise coupled to the client device 202, or the network device 206. Alternately, it will appreciate that there may be multiple networks and the external server(s) 208 may communicate over all, some, or one of the multiple networks.

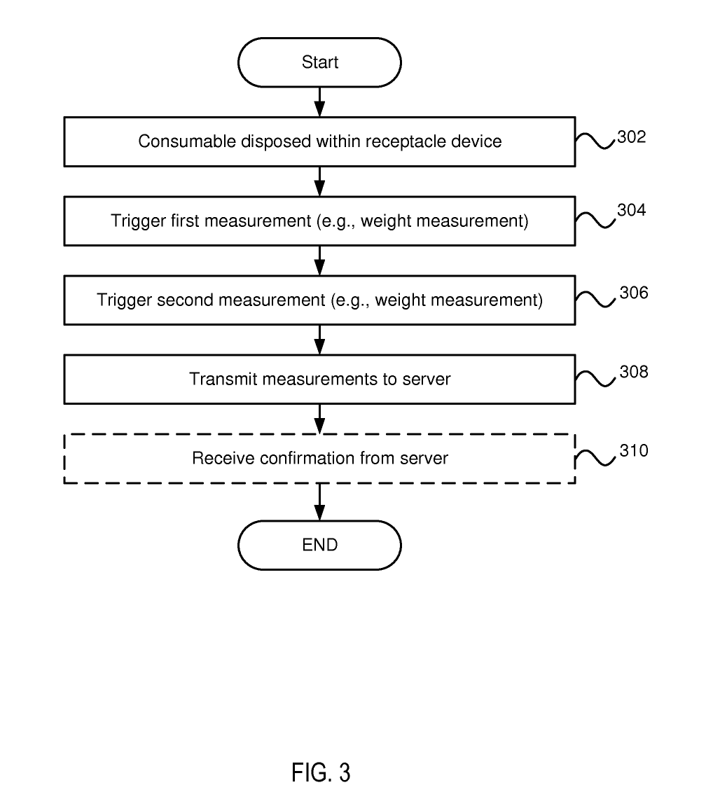

FIG. 3 is an example method of operation for a receptacle device (e.g., receptacle device 100) according to some embodiments. It will be appreciated that although the steps 302-310 below are described in a specific order, the steps 302-310 may also be performed in a different order. Each of the steps 302-310 may also be performed sequentially and/or in parallel with one or more of the other steps 302-310. In some embodiments, operation of the receptacle device may include a greater or lesser number of such steps.

In step 302, a consumable (e.g., consumable 112) is disposed within the receptacle. The consumable may be any food (perishable or non-perishable) or other nonfood item that is used (e.g., consumed). For example, the consumable may be rice, sugar, butter, cereal, quinoa, meat, milk, salt, spices, fruit, or the like. In another example, the consumable may be paper towels, toilet paper, soap, or the like. As discussed herein, the receptacle may be a plate, container for containing the consumable, basket, box, or the like.

In step 304, a first weight measurement of the consumable is detected by a sensor (e.g., sensor 104). In some embodiments, the first weight measurement is detected (or, “triggered”) when the lid (e.g., lid 106) is closed and/or movement of the receptacle stops (e.g., as sensed by a motion sensor 118). In some embodiments, the first weight measurement is adjusted based upon a first measurement detected by a second sensor (e.g., sensor 114). This can be helpful, for example, when there are objects stacked on the top of the receptacle device.

In step 306, a second weight measurement is triggered by the sensor device. The measurement may be triggered, for example, based upon a predetermined amount of time from the first measurement, and/or based upon additional movement of the receptacle detected by a movement sensor (e.g., movement sensor 118). In some embodiments, the second weight measurement may be adjusted based on a second measurement taken by the second sensor.

In step 308, the weight measurements are transmitted to the server system 204 by the client device. In some embodiments, the measurements may be sent together, although in other embodiments, they may be sent individually (e.g., after each measurement is detected). It will be appreciated that the receptacle device 100 may transmit the change (e.g., a delta) between the measurements. In some embodiments, the receptacle device 100 may aggregate the measurements and provide a statistical measurement (e.g., an average mean or median of any number of weights). The communication module (e.g., communication module 122) may transmit the measurements to the server system 204 (e.g., through a home network, client device 202, and/or the like).

In various embodiments, each measurement by a sensor may be associated with a timestamp. For example, the receptacle device 100 may provide a sensor measurement and a timestamp (or any value that represents elapsed time) to the server system 204. In another example, the server system 204 and/or the client device 202 may associate a timestamp or other value with a sensor measurement when (or approximately when) the sensor measurement is received. If the client device 202 associates and/or generates a timestamp with the sensor measurement, the client device 202 may provide the sensor measurement and timestamp to the server system 204 and/or any number of external servers 208. Although a timestamp may be generally discussed in some embodiments herein, it will be appreciated that any value that may represent elapsed time and/or priority may be used with or instead of a timestamp.

Any number of sensor measurements may be associated with any number of timestamps. For example, two sensor measurements (e.g., one sensor measurement from the base of the container and another sensor measurement from the lid of the container) generated or received at approximately similar times may be associated with a single timestamp value (or value representative of time). Alternately, each sensor measurement may be associated with its own timestamp.

The timestamp or value that represents elapsed time may assist in assessing the measurement values for modeling, tracking, and/or determining changes (e.g., of consumption, use, or potential expiration) over time.

In step 310, if the measurements were successfully received by the server system 204, a user device (e.g., client device 202) and/or receptacle device may receive a confirmation message from the server, although other embodiments may forgo the confirmation message.

It will be appreciated that the receptacle device may periodically send measurements from any number of sensors to the server system 204 and/or the client device 202. For example, the receptacle device may send a measurement upon movement or upon a predetermined duration of time after movement has been stopped. Additionally and/or alternatively, the receptacle device may send measurements when a change in measurement has been detected, when the lid of the receptacle device is removed, when the lid is closed, and/or when a network connection is present (e.g., when a Bluetooth signal is detected from the client device 202).

The number of measurements and the duration between measurements may be different depending upon the consumable, changes in measurements over time (e.g., measurements indicate an increase in humidity that may limit the usefulness or freshness of the consumable), rules established by the server system 204, and or user rules (e.g., provided by the user via the client device 202 and/or the server system 204).

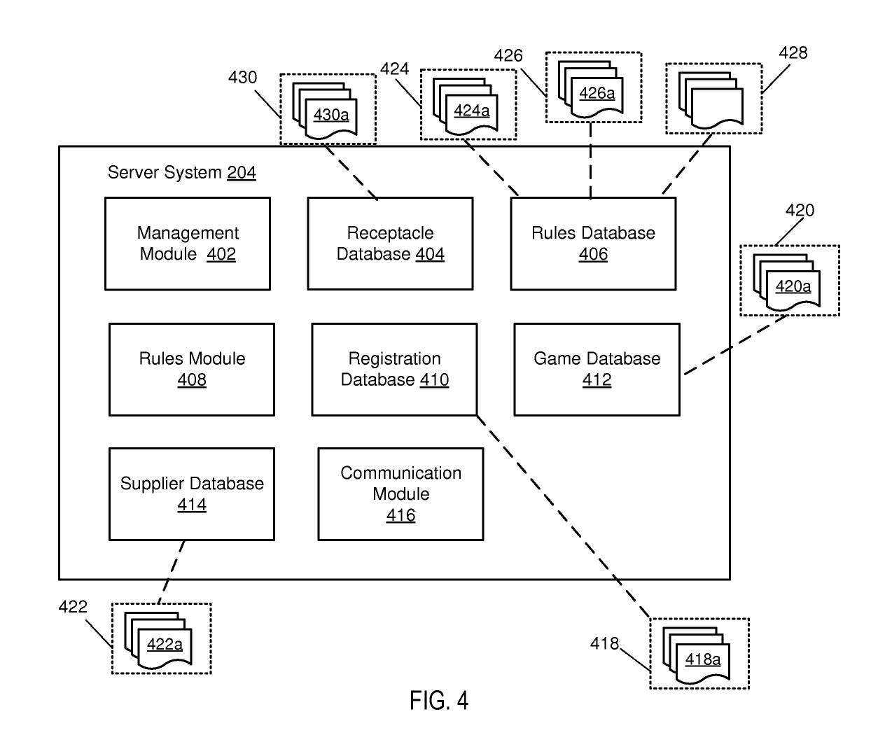

FIG. 4 is a block diagram of a server system 204 according to some embodiments. The server system 204 includes a management module 402, a receptacle database 404, a rules database 406, a rules module 408, a registration database 410, a game database 412, a supplier database 414, and a communication module 416. Generally, the server system 204 is configured to analyze data (e.g., weight values) received from one or more receptacle devices 100 and perform a variety of actions based upon that data and/or analysis. For example, the server system 204 may order more of a consumable good (e.g., sugar) from an online retailer (e.g., an external server 208 such as AMAZON) when a weight of that consumable in one or more receptacle devices 100 is below a predetermined threshold and/or an expiration date associated with the consumable is exceeded.

In some embodiments, the management module 402 may be configured to create, read, update, delete, or otherwise access, receptacle records 430 stored in the receptacle database 404, registration records 418 stored in registration database 410, game records 420 stored in the game database 412, supplier records 422 stored in the supplier database 414, and/or rules 424-428 stored in the rules database 406. The management module 402 may perform any of these operations either manually (e.g., by an administrator interacting with a GUI) or automatically (e.g., by the rules module 408 in response to a satisfied trigger condition defined in one of the rules 424-428).

In the illustrated embodiment, the receptacle records 430 store a variety of information about the receptacle devices 100. For example, the receptacle records 430 may each include any number of the following:
receptacle identifier that uniquely identifies a receptacle device in communication with the server system 204 via network 210. For example, receptacle record 430a may include a receptacle identifier that uniquely identifies receptacle device 100. In some embodiments, the receptacle identifier may itself be a scannable code (e.g., scanned from the receptacle device), or it may reference a scannable code. In the illustrated embodiment, the scannable code may be the tag 108. Scannable codes include, for example, QR codes, a UPC codes, and RFIDs. It will be appreciated that the receptacle identifier may be represented by the tag 108 and/or display 110. In some embodiments, a receptacle identifier may be generated by the client device 202 or the server system 204. The generated receptacle identifier may be associated with the user (e.g., the user account identifier discussed herein) and/or the receptacle device in any number of ways (e.g., by a serial number associated with the receptacle device.
user account identifier that identifies a user account associated with the receptacle device. As discussed herein, when a user registers a receptacle device (e.g., via client device 202), that receptacle device may become associated with that user account in the receptacle database 404.
receptacle attribute(s), including, for example, a receptacle type (e.g., jar, can, box, plate, dish, and the like), a receptacle size (e.g., volume, weight), type of sensors (e.g., weight sensors, humidity sensors, temperature sensors), and/or the like.
measurement data, including, for example, historical and/or current measurement data for the consumable stored by the identified receptacle. For example, data may include weights, changes in weight, temperatures, changes in temperature, humidity, or changes in humidity. In some embodiments, measurement data is cleared, deleted, and/or stored when the consumable is emptied (or substantially emptied) from the receptacle container.
rule identifier(s) that uniquely identify rule(s) stored in the rules database 406. In the illustrated embodiment, the rules database 406 may store a variety of different types of rules, such as consumable rules 424, nutrition rules 426, and game rules 428, although in other embodiments, rules 424-428 may be divided into a lesser or greater number of such rules. In other embodiments, each rule type may be stored in a different database (e.g., consumable rule database, nutrition rule database, game rule database). It will be appreciated that the receptacle records 430 may include any number of rules rather than rule identifiers.

Consumable Rules

The consumable rules 424 allow the server system 204 to perform a variety of actions (e.g., ordering more consumables when the quantity is low) based on consumable data received from the receptacle devices 100. In some examples, the consumable rules 424 may include any number of the following:
consumable rule identifier that uniquely identifies the consumable rule.
consumable type that identifies a type of consumable associated with the rule. The consumable type may be, for example, a generic type (e.g., “cereal”), or it may be a brand type (e.g., “KELLOGG'S FROSTED FLAKES”), or combination thereof.
expiration value that identifies a shelf life or expiration date for the associated consumable type. For example, the expiration value may be a duration (e.g., two days, one week, or 2 years), and/or a specific date (e.g., Jun. 23, 2017).
nutritional data for the associated consumable type. The nutritional data may include, for example, an amount of nutrients (20 g carbs, 10 g fat, 5 g protein) per serving (e.g., 8 oz.), amounts of ingredients, and/or amounts of vitamins of the consumable.
threshold conditions that, when satisfied, trigger one or more actions. The conditions may include any number of the following:
   if a consumable 112 weight is less than a predetermined amount (e.g., 20 g), then the condition is satisfied.
   if a consumable 112 change in weight over a predetermined amount of time is greater than a predetermined amount (e.g., 8 oz.), then the condition is satisfied.
   if the receptacle device 100 is “empty,” then the condition is satisfied.
   if a current date is on are after the expiration date, then the condition is satisfied.
   if the associated consumable 112 has been in the receptacle device 100 for longer time than the expiration value, then the condition is satisfied.
   if a temperature and/or humidity inside and/or outside the receptacle device exceeds a predetermined threshold, then the condition is satisfied.
threshold value(s), including, for example, a threshold weight. One or more actions may be triggered based on whether a threshold value is exceeded and/or not met.
action(s) may include, for example, some or all of the following:
   send an alert to a user device 202, as discussed further herein.
   order more of the consumable 112, as discussed further herein.
   modify the expiration value (e.g., shorten shelf life based on temperate and/or humidity).

Nutrition Rules

The nutrition rules 426 may allow the server system 204 to perform a variety of actions based on consumable data received from the receptacles devices 100. For example, the server system 204 may utilize any number of nutrition rules 426 to enable alerting users that too many carbohydrates have been consumed or when a balanced diet including one or more consumables over time is achieved. The nutrition rules 426 may include, for example, any number of the following:
nutrition rule identifier that uniquely identifies the nutrition rule.
nutrition rule type (e.g., “weight loss,” “weight gain,” marathon training,” “strength training,” “healthy balance,” “disease prevention,” “medical treatment,” and so forth).
maximum nutrients (e.g., carbohydrates, cholesterol, fats, proteins, fiber, minerals, proteins, vitamins, and so forth) allowed over a predetermined amount of time (e.g., day, week, month, year, and so forth).
minimum nutrients expected over a predetermined amount of time
threshold conditions that, when satisfied, trigger one or more actions. The conditions, for example, may include one or more of the following:
   if a change in weight of any number of consumables 112 exceed the maximum allowed nutrients over the predetermined amount of time, then the condition is satisfied.
   if a change in weight of any number of consumable 112 is below the minimum nutrients over the predetermined amount of time, then the condition is satisfied.
action(s) may be are triggered when a threshold condition is satisfied. The actions may be triggered, for example, by the rules module 408. The actions may include, for example, sending an alert to a user, a second user (e.g., nutritionist, doctor, or parent), or a social network, as discussed herein.

Game Rules

The game rules 428 may enable an interactive entertainment feature based on nutritional information of consumables and/or any other information regarding consumables stored and/or consumed by a user (or combination of users such as a family). This may, for example, promote healthier eating and consumption habits. In some embodiments, a user may create or join a game with other users based on their location (e.g., by mile radius, zip code, or the like) or user invitation. In various embodiments, a game may be created for a single user (e.g., to personally compete for badges or achievements). A user may be awarded a score and/or ranking relative to game thresholds and/or other users in the game. The user may create rules to set achievements, goals, and objectives. A user's score and/or ranking may increase, for example, when they consume more water, and decrease, for example, when they consume more soda.

In some embodiments, the game rules 428 may define one or more actions that are triggered based upon a user's current score and/or ranking. For example, the rules 428 may trigger the server system 204 to generate a status message informing the user of their current ranking (e.g., when they move up or down in the rankings, when they obtain the top ranking, and so forth) or as a game period ends (e.g., the game may end after a period of time). The rules 428 may also trigger the server system 204 to award “badges” to selected users based on their score and/or ranking. For example, the server system 204 may award a badge to all users with a score and/or ranking exceeding a predetermined threshold.

In some embodiments, a user's score may be based on an amount of nutrients consumed by a user as measured by a change in weight of consumables stored in each of the receptacle devices associated with that user's account. For example, a score may be generated based on an amount of consumed fat, carbohydrates, protein, salt, fiber, vitamins, and so forth. In some embodiments, consumed amounts may be based on a predetermined period of time, e.g., current day, previous day, previous week, previous month, previous year, and so forth.

For example, a user may have two or more receptacle devices holding any number of different consumables. One or more sensors on the receptacle devices may provide information regarding consumption of the consumable (or expiration of the consumable) to the server system 204. The server system 204 may be informed (e.g., by the user using an application on the client device 202) of the type of consumable in each receptacle device. The server system 204 may also have nutrient information (e.g., quantities and types of different nutrients in the different receptacle devices) associated with the consumables. The sensor(s) may provide measurements regarding changes in the consumables and the server system 204 may track overall nutrient values consumed over the different receptacle devices (e.g., determining a total number of carbohydrates consumed based on measurements of different consumables in different receptacle devices).

Utilizing one or more game rules 428, the server system 204 may compare consumption of any number of nutrients to thresholds and/or compare consumption to other users (e.g., players) associated with the game. For example, the server system 204 may generate any number of scores regarding consumption of any number of consumables. Utilizing the one or more game rules 428 and/or the scores, the server system 204 may provide alerts, awards, badges, game messages (e.g., informing the user that they are in the lead as being most healthy or providing alerts that someone is beating their score).

In another example, utilizing one or more game rules 428, the server system 204 may compare consumption of any number of nutrients to thresholds associated with a game for a single user. For example, the server system 204 may generate any number of scores regarding consumption of any number of consumables. Utilizing the one or more game rules 428 and/or the scores, the server system 204 may provide alerts, awards, badges, and game messages (e.g., informing the user that they have surpassed a personal objective or met a personal achievement).

It will be appreciated that the server system 204 may create default rules for different goals. For example, the user may indicate their interests and/or their medical condition. The server system 204 may create or instantiate rules to encourage the user to meet objectives or achievements. For example, the user may indicate that they are diabetic. Based on the consumables in the receptacle device(s) 100 associated with the user, the server system 204 may create or instantiate rules regarding use or consumption of the consumables to encourage healthy behavior. The rules may be oriented for general health, for a group of health issues (e.g., obesity), and/or for a specific condition (e.g., diabetes). Based on consumption and/or use of the consumables as detected/determined by the server system 204, the server system 204 may provide alerts encouraging the user and/or generating awards (e.g., badges) when the user's scores meet or exceed trigger conditions as set by the rules.

In some embodiments, the rules module 408 may retrieve and executes rules 424-428 to perform any number of actions, as described herein, such as alerting users when a consumable quantity is low, ordering more of a consumable (e.g., from AMAZON) when a consumable quantity is low, sending an alert to users that have consumed more than the allotted amount of a nutrient (e.g., carbs), or providing an interactive game to users. The rules module 408 may further provide administrative capabilities as well. For example, an administrator may create new rules, or edit existing rules, via a GUI executing on one of the devices 204 or 202-218.

It will be appreciated that in some embodiments, each rule type 424-428 may be executed and retrieved by a different module (e.g., a consumable module, a nutrition module, a game module).

The registration database 410 may store registration records 418 for each user. For example, the registration records 418 may comprise a user identifier, a username, a password, a receptacle identifier for each associated receptacle device, and so forth. Registration is further discussed herein.

The game database 412 stores and/or manages game records 420. The game records 420 may include, for example, some or all of the following:
game identifier that uniquely identifies a game instance.
user identifier(s) that uniquely identifies users (e.g., players) of the identified game instance.
current score associated with each user identifier.
Location to identify users (e.g., city, town, zip code, and/or radius).

The game database 412 may be used by the server system 204, for example, to generate a “leaderboard” comprising an ordered list (or, “ranking”) of users in a game instance based on their current scores. Based on the game rules 428, the leaderboard may be displayed on each of the user devices (e.g., user device 202) either on demand (e.g., at the request of a user) or at a predetermined time, such as when a user logs in to the game.

The leaderboard or other information may be provided to a social networking platform (e.g., external server(s) 208), different users client devices (e.g., smart phones), and/or a website (e.g., generated by a webserver) that provides gameplay information, allows for registration, and/or the like.

The supplier database 414 may be configured to store and/or manage supplier records 422. The supplier records 422 may include, for example, some or all of the following:
a supplier identifier that identifies a supplier selling goods online (e.g., via external server(s) 208). By way of example, merchants may include online retailers (e.g., AMAZON), pharmacies (e.g., CVS or WALGREENS), grocery stores (e.g., SAFEWAY), and the like. It will be appreciated that merchants include both online-only retailers, such as AMAZON, as well as “brick-and-mortar” retailers with an online presence.
consumable prices for the identified supplier. The prices, may for example, allow the server system 204 to determine the lowest current available price for a consumable. In some embodiments, the server system 204 may, based on the consumable rules 424, periodically crawl the web for consumable prices based on the consumable types associated with that user's account (e.g., as indicated in the receptacle database 404), and populate the supplier records 422 with current pricing information. In other embodiments, the server system 204 may, based on the consumable rules 424, dynamically crawl the web for pricing information in response to satisfaction of a consumable rule condition. In some embodiments, the rules module 408 may selects the supplier and/or crawls the web for pricing information, although in other embodiments, a dedicated module (e.g., a supplier module) may perform either or both tasks. In various embodiments, consumable prices may be removed or not gathered based on seller preferences and filters set by the user (e.g., the seller with the lowest price may be too far away from the user, not offer delivery, or have a bad reputation).

In various embodiments, the server system 204 may receive location information from a client device 202. The location information may indicate the location of the client device 202 (e.g., from a GPS device in the client device 202). In one example, the location information may be or include GPS information. In some embodiments, the server system 204 may periodically request location information from the client device 202. For example, if a consumable of a receptacle device 100 has been determined to be running low, the server system 204 may request location information of any number of client devices 202. The server system 204 may determine, based on the location information, closest stores that sell the consumable to one or more of the client devices 202. If the server system 204 determines that a store the sells the consumable is within a predetermined range of the client device 202 (e.g., the predetermined range being set by the user of the client device 202), the server system 204 may provide an alert to the user that the consumable is running low and/or notify that a store that sells the consumable is close by thereby allowing the user the option to resupply the consumable.

The server system 204 may identify one or more stores that sell the consumable based on the location information of client device 202. For example, the server system 204 may detect that a consumable is out or low (e.g., below a predetermined threshold or is being depleted rapidly) from a receptacle device 100 associated with a client device 202. The server system 204 may receive location information from the receptacle device 100 to determine if there are stores within a range of the location of the client device 202 that sell the consumable. The server system 204 may then provide an alert to the user with a list of stores either in order of proximity to the user (including prices at each store) or in order of price (e.g., lowest price to highest) and include distances.

In some embodiments, the server system 204 may compare prices of the consumable at both online and physical stores. The server system 204 may limit the number of physical stores to compare prices based on the location information of the client device 202 (e.g., within a range of the location identified in the location information from the client device(s) 202 associated with an account related to the receptacle device 100 that reported the measurements of the consumable that is running low). Even if the physical store has prices higher than online stores, the server system 204 may provide an alert to the user of the client device 202 for the user's convenience. Similarly, even if one physical store has prices that are higher than another physical store, the server system 204 may still provide an alert to the user of the client device 202 that the store of with the higher price is closer to the user. In some embodiments, the server system 204 may, in the alert, provide information regarding lower prices online and/or other stores that are farther away.

In some embodiments, a user may create rules in the rules database 406 that requests to be notified if a consumable is below a predetermined threshold (as predetermined by the user and stored in the rules database 406) or to be notified at predetermined intervals (or times) of the need to purchase or acquire more of the consumable. The user may also create a rule to be added in the rules database 406 to notify the user when the consumable needs to be purchased and when they are within a predetermined range (e.g., as predetermined by the user and stored in the rules database 406) regardless of price or when the price is at or below a range of prices (e.g., when the price of the consumable at the store proximate to the user is within 5% of the lowest price for the consumable at another physical store and/or available online).

It will be appreciated that all or some of the functions may occur on the client device 202. For example, the client device 202 may store and execute an agent that detects the location of the client device 202 (e.g., using the GPS device on the client device 202). The agent may (either by itself or in conjunction with the server system 204) determine stores that sell the consumable, price compare, and/or determine the range of a store to the client device 202. The agent may also determine if and/or when to notify the user of an opportunity to purchase or acquire the consumable from a physical store and/or online.

The communication module 416 may be configured to provide communication between the server system 204 and receptacle device 100. For example, the communication module 416 may establish or receive a communication connection between the receptacle device 100 and the server system 204 using network 210 in order to receive data messages comprising measurements (e.g., weight) detected by sensors 104, 114, or 120, and/or values (e.g., weight value) based on those measurements. The communication connection may comprise one or more wireless (e.g., WiFi, Bluetooth, Zigbee, RFID, NFC, and so on) and/or wired (e.g., Ethernet cable, USB, and the like) connections. In some embodiments, the communication module 416 may provide a communication connection between the server system 204 and network device 210.

It will be appreciated that although the server system 204 is described herein with many functions, they server system 204 may support any number of users by providing alerts, ordering consumables, generating scores, enabling gameplay or the like. In some embodiments, all or some of the functions may be performed by the client device. For example, a client device (e.g., a smartphone) may identify any number of receptacle devices, the types of consumables in the receptacle devices, and receive sensor information (e.g., measurement values) from the receptacle devices. Rather than the server system 204, the client device may assess nutrient value, provide alerts, enable gameplay, and/or the like as discussed herein.

In some embodiments, a receptacle container 100 may detect power levels of a power source such as a battery. The receptacle container 100 may provide power level measurements to the server system 204 at any time. In some embodiments, if the receptacle container 100 detects that the power level of a battery or other replaceable power source is running low, the receptacle container 100 may provide power level measurements and/or alerts regarding the power level to the server system 204 and/or any number of client devices 202 associated with the receptacle container 100. In one example, the receptacle container 100 provides a text alert to the client device 202 indicating that power is low.

In various embodiments, the server system 204 may automatically order new batteries or new replaceable power sources when the power level of a receptacle container 100 is low. In some embodiments, a user associated with the client device 202 may set a rule in the rules database 406 to automatically reorder batteries from one or more sellers when the power level of the batteries is below a predetermined threshold. In some embodiments, the server system 204 may price compare between any number of sellers (e.g., as identified by the user and/or in a default list) to determine the lowest price for batteries. Subsequently, the server system 204 may notify the user via their client device 202 and/or automatically reorder the batteries.

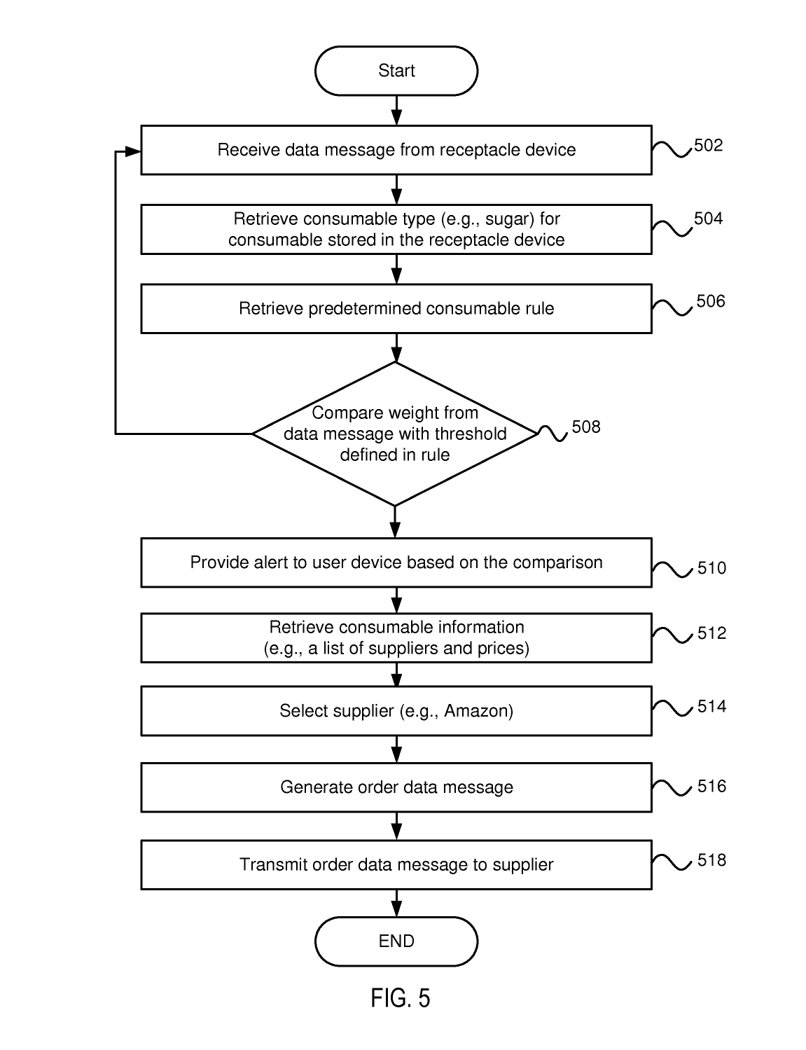

FIG. 5 is an example method of operation of a server (e.g., server system 204) executing consumable rules (e.g., consumable rules 424) according to some embodiments. Generally, the rules allow the server to generate alerts and/or purchase more goods from online retailers when quantities get low. It will be appreciated that although the steps 502-518 below are described in a specific order, the steps 502-518 may also be performed in a different order. Each of the steps 502-518 may also be performed sequentially and/or in parallel with one or more of the other steps 502-518 and/or steps 602-616, discussed below. In some embodiments, operation of the server (e.g., executing consumable rules, or otherwise) may include a greater or lesser number of such steps.

In step 502, the server system 204 receives a data message sent from a receptacle device (e.g., receptacle device 100) via a network (e.g., network 210). The data message may include, for example, a receptacle identifier that uniquely identifies the receptacle device from one or more receptacle devices in communication with the server system 204 via the network, and sensor data comprising a weight of a consumable (e.g., consumable 112) disposed within or on the receptacle device. In some embodiments, a communication module (e.g., communication module 432) receives the data message.

In some embodiments, the weight may be an actual weight (e.g., 2 oz. or 3 grams) of the consumable as measured by a sensor device (e.g., sensor device 104). The weight may be an aggregate of weight measurements taken over time (e.g., a statistical aggregate score such as a mean or median). In various embodiments, the weight may indicate a change in weight (e.g., 1 oz.) over a predetermined amount of time (e.g., a day, a week, a month, a year, and so forth) or over any number of measurements. The change in weight reflects an amount “consumed.”

In step 504, the server system 204 retrieves, based upon the receptacle identifier, a consumable type (e.g., sugar) of the consumable. In some embodiments, a management module (e.g., management module 402) retrieves the receptacle type from a receptacle record (e.g., receptacle record 430a) stored in a receptacle database (e.g., receptacle database 404).

In step 506, the server system 204 retrieves, based on the consumable type or the receptacle identifier, a predetermined consumable rule (e.g., consumable rule 424a). In some embodiments, a rules module (e.g., rules module 408) retrieves the consumable rule from a rules database (e.g., rules database 406).

In step 508, the server system 204 compares the weight of the consumable with a threshold weight (e.g., 3 oz.) defined in the predetermined consumable rule. In some embodiments, the comparison is performed by the rules module. In another example, the server system 204 may compare the speed of consumption against another rule to enable the server system 204 to provide an alert and/or reorder the consumable before the consumable may be fully consumed (or consumed before a new order is received).

In step 510, the server system 204 provides an alert (e.g., indicating a low quantity of the consumable or the speed of consumable consumption), in response to the comparison, to a remote user device (e.g., user device 202) via the network. For example, if the weight is an “actual” weight (i.e., not a change in weight, as described above), the server may provide the alert if the weight (e.g., 2 oz) is less than the predetermined threshold (e.g., 3 oz). If it is not less than the predetermined threshold, for this example, then the server may return to step 502 and wait for the next incoming data message. In some embodiments, the communication module provides the alert.

By way of further example, if the weight comprises a change in weight over time, then the server system 204 may provide the alert to the user device if the weight (e.g., 5 oz) is greater than the predetermined threshold (e.g., 4 oz.), otherwise the server may return to step 502 and wait for the next incoming data message.

In step 512, the server system 204 retrieves, in response to the comparison, consumable information associated with the consumable type. The consumable information may include, for example, a plurality of supplier identifiers each associated with a consumable price and the consumable type. The supplier identifiers may each identify a merchant (e.g., external server(s) 208). In some embodiments, the consumable information may be retrieved from supplier records (e.g., supplier records 422) from a supplier database (e.g., supplier database 414) by the management module.

The user associated with the receptacle device 100 may add or limit supplier identifiers of the plurality of supplier identifiers. For example, the user and/or the server system 204 may limit the supplier identifiers to those stores where the user is a member of a loyalty program. The user may add or limit supplier identifiers based on preference. For example, the user may prefer to avoid specific suppliers based on political, animal rights, or any other reason or affiliation and may therefore remove supplier identifiers from the plurality of supplier identifiers. Similarly, a user may add supplier identifiers.

By way of example, merchants may include online retailers (e.g., AMAZON), pharmacies (e.g., CVS or WALGREENS), grocery stores (e.g., SAFEWAY), and the like. It will be appreciated that merchants include both online-only retailers, such as AMAZON, as well as “brick-and-mortar” retailers with an online presence.

In step 514, the server system 204 selects a first supplier identifier from the plurality of supplier identifiers based on the associated consumable price for said first supplier identifier and/or a user preference (e.g., as indicated by a rule). For example, the server system 204 may select the merchant that has the lowest consumable price. In some embodiments, the server system 204 may, based on the consumable rule, periodically crawl the web for consumable prices based on the consumable types associated with that user's account (e.g., as indicated in the receptacle database), and populate the supplier database with current pricing information. In other embodiments, the server may, based on the consumable rule, dynamically crawl the web for pricing information in response to the comparison of step 508. In some embodiments, the rules module selects the supplier and/or crawls the web for pricing information, although in other embodiments, a dedicated module (e.g., a supplier module) may perform either or both of those tasks.

In another example, the server system 204 may select the merchant that may ship the quickest and/or at the lowest price. For example, if an online purchaser may immediately ship but another online purchaser has a lower price but cannot ship for a week, the server system 204 may automatically order from the online purchaser that can ship more quickly.

It will be appreciated that the user may set rules for the server system 204. In one example, the user may set a rule that automatic shipments must be made overnight, 1 day, 2 day, express, ordinary mail, or the like. The user may create different shipping rules for different consumables (e.g., some consumables like medicine may be more important than others). The user may create a rule to order a consumable based on both price and shipping speed. For example, the user may create a rule that if: 1) a consumable measurement value from a receptacle device 100 is lower than a predetermined threshold; 2) a seller's price is within 10% of the lowest price found and the seller can ship sooner than other sellers; then 3) the consumable will be ordered from the seller that can ship sooner than the other sellers. In some embodiments, the user may create a rule that orders the consumable from only one seller or a seller that ships the quickest (or within a time range) regardless of price.

In various embodiments, the user may create a rule to be notified or to order automatically if there is a sufficient sale (e.g., regardless of measurements of the consumable). For example, if the server system 204 determines that a sale of greater than 30% is detected, then the user's rule may require automatic purchasing (e.g., of a predetermined amount) or the rule may require that the user be notified of the sale.

Rules may be created to provide notification and/or reordering based on any criteria. In one example, a user may create a rule when the server system 204 determines that a consumable (e.g., beef or eggs) of a certain quality (e.g., grass-fed and organic) is available.

In step 516 the server system 204 generates an order (or, “procurement”) data message comprising the consumable type and a consumable quantity (e.g., a weight, volume, a number of units). In some embodiments, the consumable quantity may be based on a predetermined amount (e.g., set by a user via the user device). For example, the consumable rule may specify that when a particular consumable (e.g., sugar) is low, order 16 oz of that consumable. It will be appreciated that the user may include a rule that enables to the server system 204 to provide alerts or generate an order rather than both.

In various embodiments, the consumable quantity may be dynamically calculated according to an amount consumed over a predetermined period of time (e.g., one week, one month, one year, and so forth). For example, the server system 204 may look at the historical measurement data stored in the receptacle database to dynamically determine the amount consumed.

In step 518, the server system 204 transmits, via the network, the order data message to a second server (e.g., external server 208) identified by the first supplier identifier. The second server is associated with a merchant (e.g., AMAZON), as described above. The second server may fulfill the order and ship the consumable to the user.

As discussed herein, the receptacle device 100 may take measurements of any kind of consumable including non-food consumables. In one example, the receptacle device 100 may be a container that holds diapers. The receptacle device 100 may provide sensor information regarding the diapers. The user associated with the receptacle device 100 may generate any number of rules indicating when to reorder diapers and/or send alerts to the user device 204 regarding low quantities of diapers. For example, a user may create a rule in the account associated with the receptacle device 100 that diapers are to be reordered when weight as reported by the receptacle device 100 falls below a threshold (e.g., when the weight indicates that there are fewer than seven diapers left in the receptacle device 100). The user may create a rule that reorders diapers (e.g., a specific brand from AMAZON or any other store (either physical or online)) when the sensor measurements from the receptacle device 100 are at or below a predetermined threshold.

Similarly, the user may create a rule to reorder consumables and/or provide alerts based on a current sensor measurement and a rate of use based on past sensor measurements. For example, if past sensor measurements indicate a rate of use of diapers and if a current sensor measurement from the receptacle device 100 is at or below a predetermined threshold, the server system 204 may reorder and/or provide alerts. If the rate of use of the consumable is high, the server system 204 may set a higher predetermined threshold (e.g., indicating more diapers or more toilet paper are/is present) to compare to the current sensor measurement in order to reorder or provide alerts more quickly (e.g., to avoid running out). Different rates of use and/or different consumable types may, in some embodiments, be associated with different thresholds thereby allowing more efficient ordering and/or alerts.

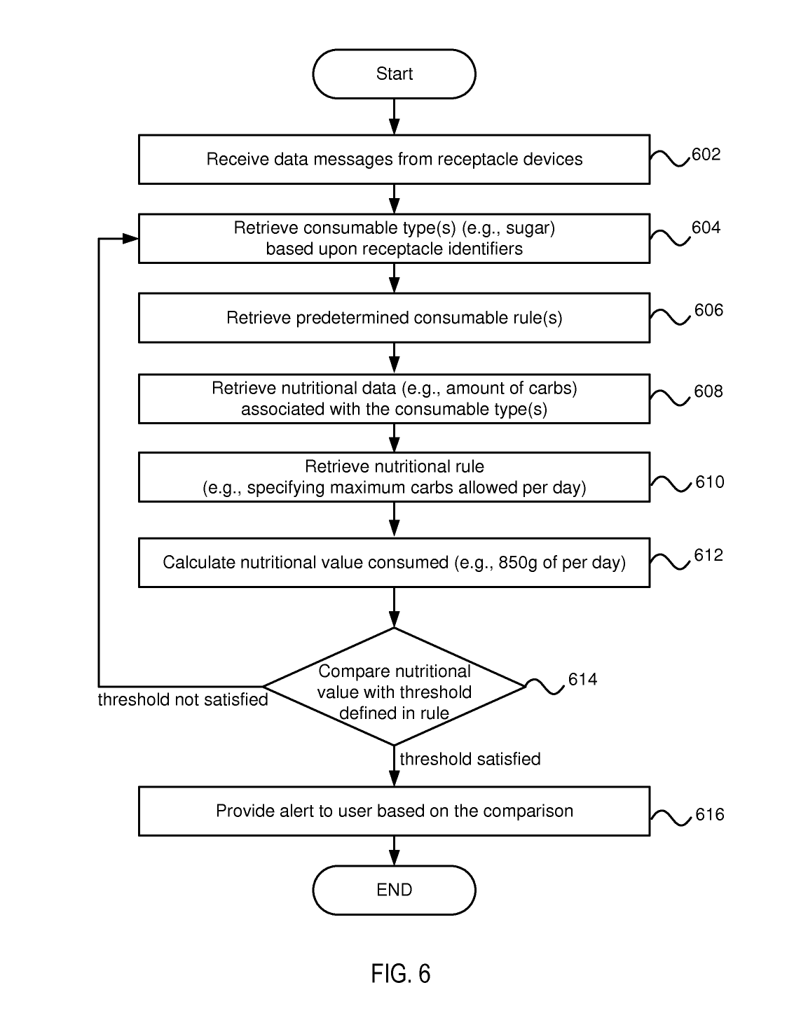

FIG. 6 is an example method of operation of a server (e.g., server system 204) executing consumable rules (e.g., consumable rules 424) and nutritional rules (e.g., nutritional rules 426) according to some embodiments. Generally, the rules allow the server system 204 to determine a single nutritional value for the amount of goods consumed across multiple receptacle devices.

It will be appreciated that although the steps 602-616 below are described in a specific order, the steps 602-616 may also be performed in a different order. Each of the steps 602-616 may also be performed sequentially and/or in parallel with one or more of the other steps 602-616 and/or steps 512-518 (discussed above). In some embodiments, operation of the server (e.g., executing consumable and/or nutritional rules, or otherwise) may include a greater or lesser number of such steps.

In step 602, the server system 204 receives a first data message sent from a first receptacle device (e.g., receptacle device 100) via a network (e.g., network 210) and a second data message sent from a second receptacle device (e.g., additional receptacle devices 100). The data messages may each include, for example, a receptacle identifier that uniquely identifies the receptacle device from a plurality of receptacle devices connected to the server via the network, and sensor data comprising a weight of a consumable (e.g., consumable 112) disposed within or on the receptacle device. In some embodiments, a communication module (e.g., communication module 432) receives the data messages.

In step 604, the server system 204 retrieves, based upon the receptacle identifiers, a consumable type (e.g., sugar) for each of the consumables (or, “first” and “second” consumables). In some embodiments, a management module (e.g., management module 402) retrieves the receptacle type(s) from receptacle record(s) (e.g., receptacle record 430a) stored in a receptacle database (e.g., receptacle database 404).

In step 606, the server system 204 retrieves, based on the consumable type(s) or the receptacle identifiers, a predetermined consumable rule (e.g., consumable rule 424a) for each consumable type or receptacle identifier. In some embodiments, a rules module (e.g., rules module 408) retrieves the consumable rule(s) from a rules database (e.g., rules database 406).

In step 608, the server system 204 retrieves, based on the consumable types or the receptacle identifiers, nutritional data for the consumables. For example, the nutritional data may include one or more nutrients (e.g., carbs, fats, proteins, vitamins, macronutrients, micronutrients, and so forth) associated with the consumable type of the first consumable, and (ii) one or more nutrients associated with the consumable type of the second consumable, each of the nutrients having an associated nutrient weight (e.g., 5 g of fat and 10 g of protein) per serving (e.g., 1oz). In some embodiments, the nutritional data may be stored in corresponding consumable rules.

In step 610, the server system 204 retrieves, based on the nutritional data, a predetermined nutrition rule (e.g., nutrition rule 426a). In some embodiments, a rules module (e.g., rules module 408) may retrieve the nutrition rule from a rules database (e.g., rules database 406).

In step 612, the server system 204 may calculate a nutritional value for the consumed goods from the nutritional data using the weight from the data messages. In some embodiments, the nutritional value is additionally calculated based on one or more formulas, or other metrics, defined in the nutritional rule. For example, the nutritional value may be calculated as an aggregate weight of nutrients (e.g., carbs) in the consumables.

For example, if the nutritional data and weights in the data messages are as follows:
nutritional data for first consumable=100 g of carbs per ounce,
nutritional data for second consumable=50 g of carbs per ounce,
weight of consumable in the first data message=5 ounces over a period of one day,
weight of consumable in the second data message=7 ounces over a period of one day,
   then the nutritional value may be, according to one example,

(100 g/oz)*(5 oz)+(50 g/oz)*(7 g)=850 g of carbs.

In other embodiments, the nutritional value may be a weighted score that increases and/or decreases based on a health value of the nutrients. For example, carbs, fat, and sugar may reduce the score, but proteins may increase the score. Health values may be determined by any number of publicly available sources (National Institute of Health), and/or may be manually set, e.g., by an administrator and/or a user.

It will be appreciated that although only carbs and ounces are used in the above example, the nutritional value may be based on any number or type of macronutrients (e.g., carbs, fat, protein), micronutrients (e.g., vitamins), weights, and/or serving sizes. It will further be appreciated that, in some embodiments, the rules module may calculate the nutritional value.

In step 614, the server system 204 compares the nutritional value with a threshold condition of the nutritional rule. For example, the threshold condition may specify that a maximum of 300 g of carbs are allowed each day. If the threshold condition is not satisfied (e.g., nutritional value is less than 300 g of carbs) then the condition is not satisfied and the method may return to step 602.

If the threshold condition is satisfied (e.g., nutritional value exceeds 300 g of carbs), the server may provide an alert to the remote user device indicating nutritional information (step 616). The nutritional information may include, for example, the nutritional value (e.g., 850 g of carbs per day) and/or an excess weight of a nutrient (e.g., 550 g carbs) based on the threshold condition (e.g., 300 g of carbs per day). By the way of further example, the alert may display the following message on the user device:
Warning—you have eaten 850 g of carbs today, which is 550 g more than your allowed 300 g.

In some embodiments, the comparison in step 614 may be performed by the rules module, and the alert in step 616 may be generated by the rules module and provided to the remote user device by the communication module.

It will be appreciated that although the above method is discussed with reference to a first receptacle device and a second receptacle devices, the method is applicable to a server in communication with a greater or lesser number of receptacle devices.

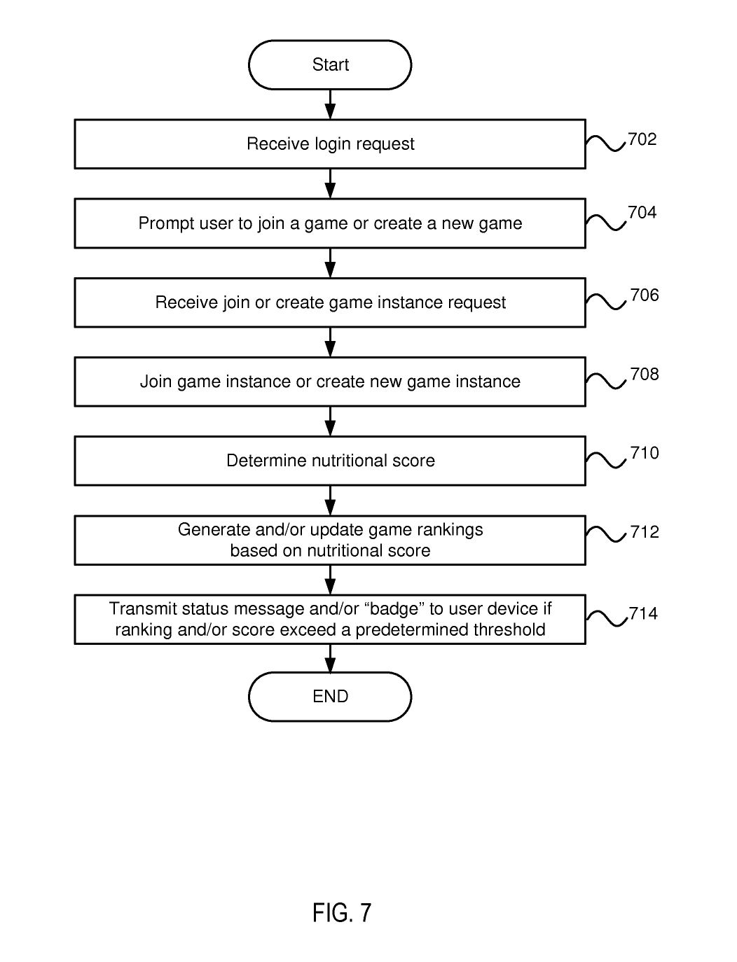

FIG. 7 is an example method of operation of a server (e.g., server system 204) executing game rules (e.g., game rules 428). This may promote, for example, healthier habits for the users. It will be appreciated that although the steps 702-718 below are described in a specific order, the steps 702-718 may also be performed in a different order. Each of the steps 702-718 may also be performed sequentially and/or in parallel with one or more of the other steps 502-518 (discussed above) and/or steps 602-620 (discussed above). In some embodiments, operation of the game may include a greater or lesser number of such steps.

In step 702, the server system 204 receives a login request from a user device (e.g., client device 202) via a network (e.g., network 210). The login request may include, for example, an account username and a password. If the login request is successful, the server may, for example, prompt the user to either join an existing game instance (e.g., provide a game invitation from another user) or create a new game instance (step 704). If the login request is denied, the method returns to step 702 and may wait to receive the next login request. In some embodiments, a communication module (e.g., communication module 426) may receive the request.

In some embodiments, the server system 204 may retrieve a list of current game instances from a game database (e.g., game database 412) and transmit them for display on the user device. In some embodiments, the current game instances may include active game instances that may be offered or interacted with by the user or the client device 202. The current game instances may be based on a location or an invitation from other user accounts. In some embodiments, a management module (e.g., management module 402) retrieves the list of current games instances from the database.

In step 706, the server system 204 receives a join game instance request or create game instance request from the user device. The request may include, for example, a game instance identifier and a user account identifier. In some embodiments, the communication module may receive the request.

In step 708, if the request is a join request, the server system 204 may update the game record (e.g., record 420a) matching the game instance identifier in the request. Alternatively, if the request is a create game request, the server may add a new record to the game database. In some embodiments, the management module may update or create the record.

In step 710, the server system 204 may determine a nutritional score associated with the account username in the request (e.g., after a period of time). For example, the score may be based on consumption data stored in the receptacle records (e.g., receptacle records 430). In some embodiments, the nutritional score may comprise the nutritional value discussed above. In some embodiments, a rule module (e.g., rule module 408) determines the nutrition score based on the game rules.

In step 712, the server system 204 may generate and/or update a “leaderboard” based on the nutritional scores for each of the accounts associated with the game instance in the game records. The leaderboard may be displayed on the user device. In step 714, the server system 204 may transmit a status message and/or “badge” for display on the user device if the ranking and/or nutritional score exceeds a predetermined threshold. For example, a badge may be award upon moving up to first place in the rankings.

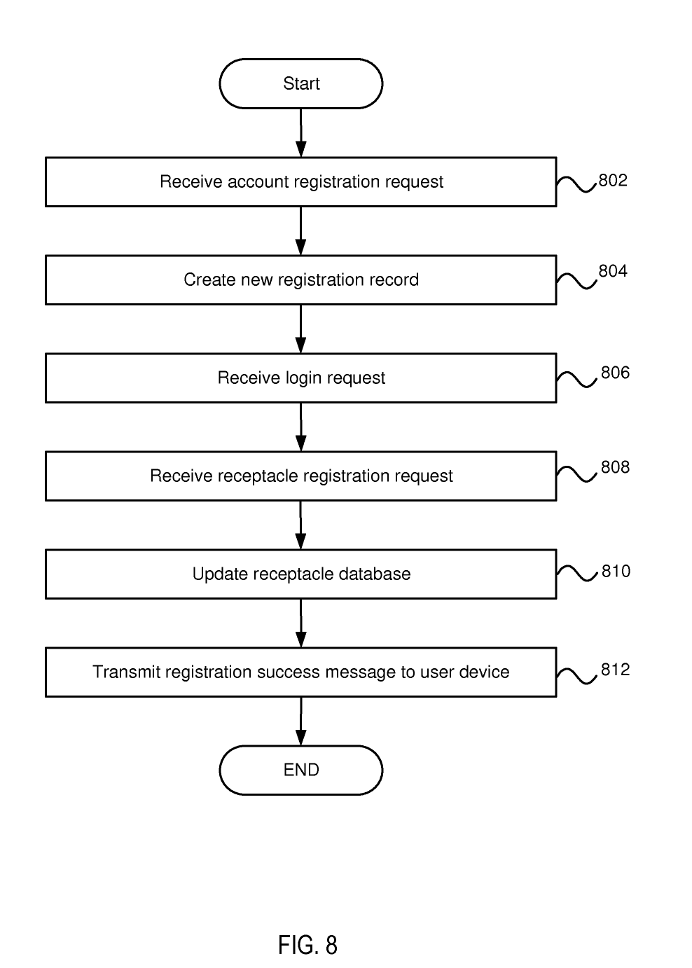

FIG. 8 is an example method of user account registration and receptacle device (e.g., receptacle device 100) registration by a server (e.g., server system 204) according to some embodiments. It will be appreciated that although the steps 802-818 below are described in a specific order, the steps 802-818 may also be performed in a different order. Each of the steps 802-818 may also be performed sequentially and/or in parallel with one or more of the other steps 802-818. In some embodiments, registration the user account and/or receptacle device 100 may include a greater or lesser number of such steps.

In step 802, the server system 204 receives an account registration request from a user device (e.g., client device 202) via a network (e.g., network 210). The registration request may include, for example, a username (e.g., “jsmith2015), password, full name (e.g., “John Smith”), birthdate, gender, physical characteristics (e.g., height, weight, etc.), mailing address (e.g., 555 First Ave, Palo Alto, Calif., 84301”), email address, and so forth.

In step 804, if the server approves the registration request, the server may create a new registration record (e.g., registration record 418a) in a registration database (e.g., registration database 410) and/or an account for the user. In some embodiments, management module (e.g., management module 402) created the registration record.

In step 806, the server receives a log-in request from the user device. The log-in request may include, for example, the username and password. If the log-in credentials are correct, the server logs the account into the system.

In step 808, the server receives a receptacle registration request from the user device. The receptacle registration request may include, for example, a receptacle identifier that uniquely identifies the receptacle device, and an account identifier associated the username. The receptacle identifier may be obtained by the client device by a variety of methods, e.g., scanning a tag (e.g., tag 108) on the receptacle device, or entering the identifier manually via the user device.

In step 810, the server updates a receptacle database (e.g., receptacle database 404) with the registration request by either creating a new receptacle record (e.g., record 430a) or, if the receptacle identifier is already stored in one of the receptacle records (e.g., records 430), updating that particular record. In some embodiments, the management module updates the receptacle database.

In step 812, the server transmits a registration success message to the user device when the receptacle database has been updated.

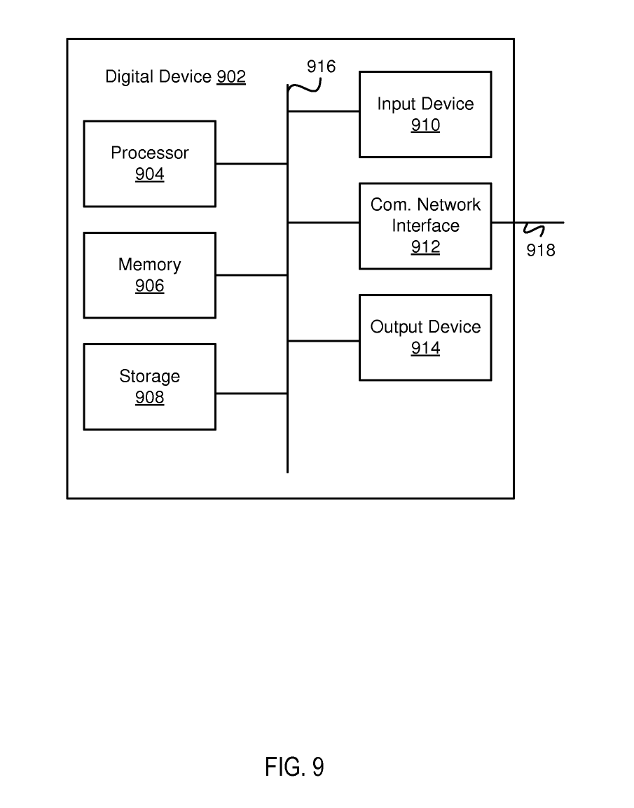

FIG. 9 is a block diagram of a digital device according to some embodiments. Any of the receptacle devices 100, user device 202, server system 204, network device 206, and/or external server(s) 208 may be an instance of the digital device 902. The digital device 902 comprises a processor 904, memory 906, storage 908, an input device 910, a communication network interface 912, and an output device 914 communicatively coupled to a communication channel 916. The processor 904 is configured to execute executable instructions (e.g., programs). In some embodiments, the processor 904 comprises circuitry or any processor capable of processing the executable instructions.

The memory 906 stores data. Some examples of memory 906 include storage devices, such as RAM, ROM, RAM cache, virtual memory, etc. In various embodiments, working data is stored within the memory 906. The data within the memory 906 may be cleared or ultimately transferred to the storage 908.

The storage 908 includes any storage configured to retrieve and store data. Some examples of the storage 908 include flash drives, hard drives, optical drives, and/or magnetic tape. Each of the memory system 906 and the storage system 908 comprises a computer-readable medium, which stores instructions or programs executable by processor 904.

The input device 910 is any device that inputs data (e.g., mouse and keyboard). The output device 914 outputs data (e.g., a speaker or display). It will be appreciated that the storage 908, input device 910, and output device 914 may be optional. For example, the routers/switchers may comprise the processor 904 and memory 906 as well as a device to receive and output data (e.g., the communication network interface 912 and/or the output device 914).

The communication network interface (corn. network interface) 912 may be coupled to a network (e.g., network 210) via the link 918. The communication network interface 912 may support communication over an Ethernet connection, a serial connection, a parallel connection, and/or an ATA connection. The communication network interface 912 may also support wireless communication (e.g., 902.11 a/b/g/n, WiMax, LTE, WiFi). It will be apparent that the communication network interface 912 can support many wired and wireless standards.

It will be appreciated that the hardware elements of the digital device 902 are not limited to those depicted in FIG. 9. A digital device 902 may comprise more or less hardware, software and/or firmware components than those depicted (e.g., drivers, operating systems, touch screens, biometric analyzers, etc.). Further, hardware elements may share functionality and still be within various embodiments described herein. In one example, encoding and/or decoding may be performed by the processor 904 and/or a co-processor located on a GPU (i.e., Nvidia).

It will further be appreciated that a “module,” “database,” or “sensor,” as described herein, may comprise software, hardware, firmware, and/or circuitry. In one example, one or more software programs comprising instructions capable of being executable by a processor may perform one or more of the functions of the modules, databases, or sensors, as described herein. In another example, circuitry may perform the same or similar functions. Alternative embodiments may comprise more, less, or functionally equivalent modules, or sensors, and still be within the scope of present embodiments. For example, as previously discussed, the functions of the various modules, databases, or sensors, may be combined or divided differently.

It will be further appreciated that the “databases,” as described herein, may be any structure suitable for storing the rules and/or records described herein (e.g., Oracle database, MySQL database, other SQL or relational database, NoSQL database, flat database, table, data store, and/or so forth).

It will further be appreciated that “nutrients,” as described herein, may include both macronutrients (e.g., carbs, fat, protein) and micronutrients (e.g., vitamins).

The above-described functions and components may comprise instructions that are stored on a storage medium such as a computer readable medium. Some examples of instructions include software, program code, and firmware. The instructions may be retrieved and executed by a processor in many ways.

The present invention(s) are described above with reference to exemplary embodiments. It will be apparent that various modifications may be made and other embodiments can be used without departing from the broader scope of the present invention(s). Therefore, these and other variations upon the exemplary embodiments are intended to be covered by the present invention(s).

1. A method comprising:
receiving, at a server system, a data message sent from a receptacle device via a network, the data message including:
(i) a receptacle identifier that uniquely identifies the receptacle device from one or more receptacle devices connected to the server via the network,
(ii) sensor data comprising a weight of a consumable disposed within or on the receptacle device;
retrieving, by the server based upon the receptacle identifier, a consumable type of the consumable;
retrieving, by the server based on the consumable type or the receptacle identifier, a predetermined consumable rule;
comparing, by the server, the weight of the consumable with a threshold weight defined in the predetermined consumable rule; and
providing an alert, by the server in response to the comparison, to a remote user device.

2. The method of claim 1, wherein the alert indicates a low quantity of the consumable.

3. The method of claim 1, further comprising:
retrieving, by the server in response to the comparison, a supplier identifier based on the consumable type or the receptacle identifier, the supplier identifier associated with the consumable type;
generating, by the server, an order data message comprising the consumable type and a consumable quantity; and
transmitting, by the server via the network, the order data message to a second server identified by the supplier identifier.

4. The method of claim 1, further comprising:
retrieving, by the server in response to the comparison, consumable information associated with the consumable type, the consumable information comprising a plurality of supplier identifiers each associated with a consumable price and the consumable type;
selecting, by the server, a first supplier identifier from the plurality of supplier identifiers based on the associated consumable price for said first supplier identifier;
generating, by the server, an order data message comprising the consumable type and a consumable quantity; and
transmitting, by server via the network, the order data message to a second server identified by the first supplier identifier.

5. The method of claim 3, wherein the consumable quantity is determined, by the server, using the weight from the sensor data.

6. The method of claim 4, wherein the order message is generated and transmitted without instruction from the remote user device.

7. The method of claim 1, further comprising:
receiving, at the server, a second data message sent from a second receptacle device via the network, the second data message including:
(i) a second receptacle identifier that uniquely identifies the second receptacle device from a plurality of receptacle devices connected to the server via the network,
(ii) sensor data comprising a weight of a second consumable disposed within or on the second receptacle device;
retrieving, by the server based upon the second receptacle identifier, a consumable type of the second consumable;
retrieving, by the server, nutritional data comprising (i) one or more nutrients associated with the consumable type of the first consumable, (ii) one or more nutrients associated with the consumable type of the second consumable, each of the nutrients having an associated nutrient weight;
retrieving, by the server based on the nutritional data, a predetermined nutritional rule;
calculating, by the server, a nutritional value from the nutritional data using the weight from the data message and the weight from the second data message;
comparing, by the server, the nutritional value with a threshold condition of the nutritional rule;
providing a second alert, by the server based upon the comparison, to the remote user device indicating nutritional information.

8. The method of claim 7, wherein the weight in the data message and the second data messages each comprise a change in weight over a predetermined amount of time.

9. The method of claim 8, further comprising determining, by the processor, (i) a first carbohydrate weight for the consumable using the nutritional data and the sensor data from the data message, and (ii) a second carbohydrate weight for the second consumable using the nutritional data and the sensor data from the second data message.

10. The method of claim 9, wherein the nutritional value comprises an aggregate of the first carbohydrate weight and the second carbohydrate weight.

11. The method of claim 10, wherein the nutritional information comprises (i) the nutritional value and (ii) and an excess weight of carbohydrates, the excess weight calculated using the threshold weight of the nutritional rule and the aggregate weight.

12. The method of claim 7, wherein the nutrients is carbohydrates, cholesterol, fats, sugars, fiber, vitamins, minerals, or proteins.

13. A system comprising:
a processor,
a registration database configured to cooperate with the processor store a plurality receptacle records, each receptacle record comprising a receptacle identifier and a consumable type;
a consumable rules database configured to cooperate with the processor to store a plurality of consumable rules, each consumable rule associated with a consumable type;
a communication module configured to cooperate with the processor to receive a data message sent from a receptacle device, the data message comprising
(i) a receptacle identifier that uniquely identifies the receptacle device from a plurality of receptacle devices connected to the server via a network,
(ii) sensor data comprising a weight of a consumable disposed within or on the receptacle device;
a registration module configured to cooperate with the processor to retrieve from the registration database, based on the receptacle identifier, a consumable type associated with the receptacle identifier;
a rule module configured to cooperate with the processor to
(i) retrieve from the consumable rules database a first consumable rule associated with the retrieved consumable type,
(ii) determine, based on the first consumable rule, whether the weight of the consumable meets or exceeds a threshold weight identified in the first consumable rule,
(iii) provide an alert, in response to a determination by the processor that the weight of the consumable meets or exceeds the threshold weight identified in the first consumable rule, to a remote user device.

14. The system of claim 13, wherein the rule module is further configured to cooperate with the processor to execute an instruction, in response to a determination by the processor that the weight of the consumable meets or exceeds the threshold weight identified in the first consumable rule, thereby causing the server to generate and transmit an order message to a second server via the network, the order message indicating a consumable for purchase based on the consumable type.

15. The system of claim 14, wherein the rule module is further configured to cooperate with the processor to select the second server from a plurality of different servers based upon a cost of the consumable associated with the second server.

16. The system of claim 14, wherein the consumable records each further comprise an expiration value associated with the consumable type.

17. The system of claim 13, wherein the rule module is further configured to cooperate with the processor to determine, based on an expiration value defined in the first consumable rule, whether the consumable has expired.

18. The system of claim 17, wherein the rule module is further configured to cooperate with the processor to execute an instruction, in response to a determination by the processor that the consumable has expired, thereby causing the server to transmit an order message to a second server via the network, the order message indicating a consumable for purchase based on the consumable type.

19. The method of claim 13, wherein the sensor data further comprises temperature data, the expiration value being modified based upon the temperature data.

20. The system of claim 13, wherein the weight from the data message comprises a change in weight over time, and wherein the plurality of consumable rules identify a weight of carbohydrates for the associated consumable type, and wherein the rule module is further configured to cooperate with the processor to
(i) calculate a weight of carbohydrates for the consumable associated with the receptacle device based on the first consumable rule and the sensor data from the data message,
(ii) determine whether the weight of carbohydrates for the consumable associated with the receptacle device meets or exceeds a threshold weight identified in a user defined nutrition rule retrieved from a nutrition database by the rule module, and
(iii) provide a second alert to the remote user device in response to determining that the weight of carbohydrates for the consumable associated with the receptacle device meets or exceeds the threshold weight identified in the user defined nutrition rule.

21. The system of claim 13, wherein the receptacle identifier comprises a QR code.
